(19) United States
(12) Patent Application Publication
(10) Pub. No.: US 2023/0331520 A1
(43) Pub. Date: Oct. 19, 2023

(54) METHOD FOR ALIGNING GUIDE RAILS OF AN ELEVATOR

(71) Applicant: Kone Corporation, Helsinki (FI)

(72) Inventors: Mikael HAAG, Helsinki (FI); Harri MAKINEN, Helsinki (FI); Markku HAIVALA, Helsinki (FI); Joonas JOKELA, Helsinki (FI)

(73) Assignee: Kone Corporation, Helsinki (FI)

(21) Appl. No.: 18/338,874

(22) Filed: Jun. 21, 2023

Related U.S. Application Data
(63) Continuation of application No. PCT/EP2021/050077, filed on Jan. 5, 2021.

(51) Int. Cl. B66B 19/00

(52) U.S. Cl. CPC B66B 19/002

(57) ABSTRACT

The method comprises measuring a first position of the guide rail when the bolts of the fastening bracket have been opened, measuring a second position of the guide rail when the guide rail has been moved into a desired position, measuring a third position of the guide rail when the bolts of the fastening bracket have been tightened and the guide rail has been released, the difference in the second position and the third position representing a spring back of the guide rail, storing the measured position data of the guide rail in a memory, using the measured position data of the guide rail stored in the memory for adjusting guide rails.

### CROSS-REFERENCE TO RELATED APPLICATION

This application is a continuation of PCT International Application No. PCT/EP2021/050077 which has an International filing date of Jan. 5, 2021, the entire contents of which are incorporated herein by reference.

### FIELD

The invention relates to a method for aligning guide rails of an elevator.

### BACKGROUND

An elevator may comprise a car, a shaft, hoisting machinery, ropes, and a counterweight. A separate or an integrated car frame may surround the car.

The hoisting machinery may be positioned in the shaft. The hoisting machinery may comprise a drive, an electric motor, a traction sheave, and a machinery brake. The hoisting machinery may move the car upwards and downwards in the shaft. The machinery brake may stop the rotation of the traction sheave and thereby the movement of the elevator car.

The car frame may be connected by the ropes via the traction sheave to the counterweight. The car frame may further be supported with guiding means at guide rails extending in the vertical direction in the shaft. The guide rails may be attached with fastening brackets to the side wall structures in the shaft. The guiding means keep the car in position in the horizontal plane when the car moves upwards and downwards in the shaft. The counterweight may be supported in a corresponding way on guide rails that are attached to the wall structure of the shaft.

The car may transport people and/or goods between the landings in the building. The wall structure of the shaft may be formed of solid walls or of an open beam structure or of any combination of these.

The guide rails may be formed of guide rail elements of a certain length. The guide rail elements may be connected in the installation phase end-on-end one after the other in the elevator shaft by using connection plates extending between the opposite ends of the guide rail elements or by using jointing clamps attached to the opposite ends of the guide rail elements. The jointing clamps may comprise male and female attachment means for attaching to the jointing clamps and thereby also the guide rails to each other.

The guide rails may be attached to the walls of the elevator shaft with brackets along the height of the guide rails.

Several elevator cars may operate in parallel in a common shaft. The shaft may be divided into different sections with divider beams extending across the shaft. The divider beams may be positioned at a certain vertical distance from each other along the height of the shaft. The divider beams may be horizontal. The guide rails may be attached via brackets to the divider beams.

The guide rails must be aligned after they have been installed. The alignment of the guide rails may be done manually or automatically with an apparatus for aligning guide rails. A tension will, however, remain in the guide rails after the guide rail is aligned, the bracket is locked, and the guide rail is released. The remaining tension in the guide rail will cause a displacement of the guide rail when the guide rail is released after the alignment. This displacement i.e. the spring back needs to be corrected. The correction is in prior art made by trial and error. The mechanic tries to find a position from which the rail springs back to the correct position i.e. to the desired position of the guide rail. A method for correcting the position of the guide rail based on trial and error is time consuming and may require several iterations before the desired position of the guide rail is found.

### SUMMARY

An object of the present invention is a novel method for aligning guide rails of an elevator.

The method for aligning guide rails of an elevator is defined in claim 1.

The invention may speed up the alignment process of the elevator guide rails compared to prior art methods. The productivity and the precision of the guide rail alignment process may also be increased.

The invention may also eliminate variations in the quality of the alignment of the guide rails. The quality of the alignment of the guide rails will be less dependent on the person performing the alignment. A trained technician can easily make a high-quality alignment of the guide rails with the help of the invention.

The invention is easy to use and eliminates the trial and error needed in prior art methods for compensating the spring back in the guide rail alignment process.

The invention may be used in a manual alignment of the guide rails done by a mechanic with manual tools. The mechanic may travel upwards and downwards in the shaft on an installation platform being movably supported on the guide rails. The mechanic may first open the bolts of the fastening brackets and measure the first position of the guide rail. There is no tension in the guide rail in this first position. The mechanic may then move the guide rail into a correct position according to measurements made based on e.g. plumb lines arranged in the shaft. The mechanic may then measure this second position of the guide rail. The mechanic may then tighten the bolts of the fastening brackets and release the guide rail. The guide rail will because of internal stresses spring back causing a displacement of the guide rail from the correct position. The mechanic may measure this third position of the guide rail. The mechanic must in prior art again open the bolts of the fastening brackets, change the position of the guide rail and try to take account of the spring back, and then finally tighten the bolts. Several iterations may be needed in prior art manual alignment before a correct position of the guide rail is achieved. The inventive method may be used to eliminate this iteration. The mechanic will receive an estimate of the correct position of the guide rail based on the position data stored in the memory. The spring back of the guide rail is taken into consideration in the estimate. The mechanic positions the guide rail into the estimated correct position and tightens the bolts of the bracket and releases the guide rail. The spring back occurs, but it has already been taken into consideration in the estimate i.e. the guide rail will be in the correct position after the spring back has occurred.

The invention may also be used in an automatic alignment of the guide rails. An alignment apparatus for aligning guide rails may be used in an automatic alignment process. The alignment apparatus may be supported on an installation platform. Each end of an alignment unit in the alignment apparatus may be supported on the two opposite guide rails. Each end of a positioning unit in the alignment apparatus may on the other hand be supported on opposite wall structures and/or on dividing beams and/or on brackets in the shaft. A mechanic may operate the alignment apparatus via a control unit. The alignment of the guide rails may thus be done automatically with the alignment apparatus based on the measurements from the plumb lines. Opposite guide rails may thus be aligned automatically with the alignment apparatus in relation to a second direction i.e. the direction between the guide rails (DBG) and in relation to a third direction i.e. the direction between the back wall and the front wall of the shaft (BTF). The mechanic may travel on the installation platform or the mechanic may control the alignment from a position outside the shaft. The controller of the alignment apparatus will receive an estimate of the correct position of the guide rail based on the position data stored in the memory. The spring back of the guide rail is taken into consideration in the estimate. The operator positions the guide rail into the estimated correct position with the alignment apparatus after which the bolts of the bracket are tightened and the guide rail is released. The spring back occurs, but it has already been taken into consideration in the estimate i.e. the guide rail will be in the correct position after the spring back has occurred.

The invention may be used in aligning the guide rails in a new installation and in re-adjusting the alignment of the guide rails in an existing elevator.

The invention comprises measuring a first position of the guide rail after the bracket bolts have been opened, measuring a second position of the guide rail after the adjustment of the guide rail into a desired position, measuring a third position of the guide rail after the bracket bolts have been tightened and the guide rail has been released, storing the measured position data in a memory, and using the measured position data stored in the memory for adjusting guide rails. The data may be collected from earlier alignment processes in the same shaft and/or from several earlier alignment processes in different shafts. Each position of the guide rail is measured in the horizontal plane. The coordinates in the second direction i.e. the direction between the guide rails (DBG) and in the third direction i.e. the direction from the back wall to the front wall (BTF) are measured.

The measured position data of the guide rails may be categorized by at least one of the parameters in a first group of parameters or any combination of the parameters in the first group of parameters comprising: the type of guide rail, the type of fastening bracket, the number of the fastening bracket, the type of clips, the bracket distance, and optionally the type of divider beam. The type of divider beam is naturally not relevant in installations in which divider beams are not used i.e. the guide rails are attached directly to the wall structure in the shaft. The number of the fastening bracket may refer to the number of the fastening bracket calculated in the height direction of the shaft. The type of clips refers to the clips that are used to attach the guide rail to the fastening bracket.

The adjustment of the guide rail based on the earlier stored position data may be done so that the nearest match for the bracket to be adjusted is searched from the position data in the memory after which the output i.e. the measured spring back is used to correct the rail adjustment.

The adjustment of the guide rail based on the earlier stored position data may on the other hand be done so that a mathematical model is fitted to the position data stored in the memory. The mathematical model may then be used for predicting the spring back based on one or several input factor. Regression analysis may be used to fit the mathematical model into the stored data. The regression analysis may be based on a decision tree. The goal of a decision tree is to predict the outcome based on the input of various variables. Decision trees are extensively used in computer programming and in algorithms where a computer needs to decide an option based on certain criteria.

A decision tree has two components: the problem statement (represented by the root of the tree) and a set of consequences or solutions (represented by the branches of the tree). The decision tree can extend ay any length representing all options of a problem statement. A key difference between a real tree and decision trees is that the decision tree is typically an inverted tree with the root at the top. There are two types of decision trees i.e. classification trees having categorical target values and regression trees having a continuous target value.

The mathematical model may be used in the alignment of the guide rails for a specific combination of parameters. The initial position of the guide rail after the bracket bolts have been opened may be used as an input value supplied to the mathematical model. The mathematical model may give as an output a predicted position for the guide rail by taking into consideration the spring back of the guide rail. The guide rail may then be positioned in the predicted position, the bracket bolts may be tightened, and the guide rail may be released, wherein the spring back of the guide rail moves the guide rail from the predicted position to the desired position.

The invention may be further developed by using machine learning. Machine learning is the study of computer algorithms that improve automatically through experience. It is seen as a subset of artificial intelligence. Machine learning algorithms build a model based on sample data, known as “training data”, to make predictions or decisions without being explicitly programmed to do so. Machine learning algorithms are used in a wide variety of applications, such as email filtering and computer vision, where it is difficult or infeasible to develop conventional algorithms to perform the needed tasks.

The mathematical model may be trained with the input and the output data collected from several alignment projects. The advantage with the machine learning is that it can predict the spring back values also for brackets which do not have a good match in the saved data. The precision of the predictions of the machine learning model will also improve as a function of the number of alignment projects that have been done.

### DRAWINGS

The invention will in the following be described in greater detail by means of preferred embodiments with reference to the attached drawings, in which

FIG. 1 shows vertical cross-sectional view of an elevator,

FIG. 2 shows a horizontal cross-sectional view of the elevator,

FIG. 3 shows an isometric view of an apparatus for aligning guide rails in an elevator,

FIG. 4 shows a first phase of the operation of the apparatus of FIG. 3,

FIG. 5 shows a second phase of the operation of the apparatus of FIG. 3,

FIG. 6 shows an axonometric view of an elevator shaft with the alignment apparatus and an installation platform,

FIG. 7 shows a horizontal cross section of the elevator shaft provided with an installation platform,

FIG. 8 shows the principle of collecting measured position data of a guide rail,

FIG. 9 shows the principle of using measured position data in the alignment of a guide rail,

FIG. 10 shows a flow diagram for aligning guide rails of an elevator.

### DETAILED DESCRIPTION

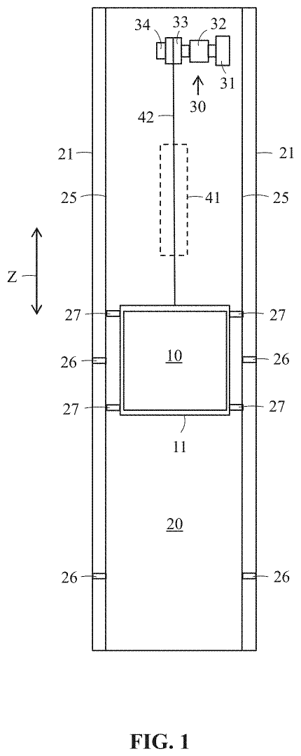

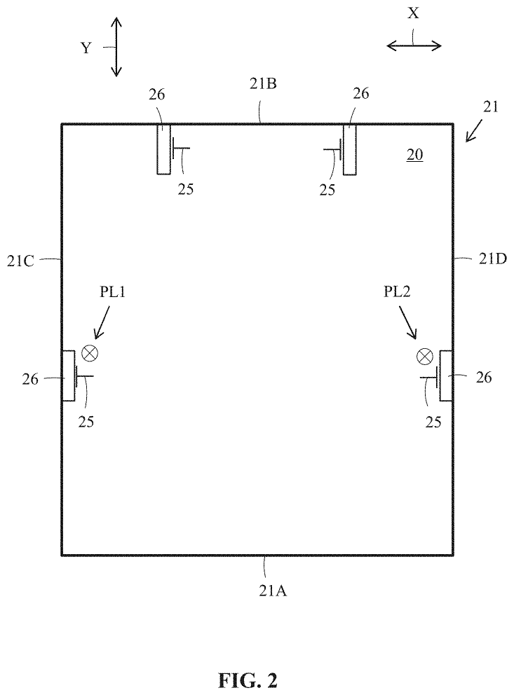

FIG. 1 shows a vertical cross-sectional view and FIG. 2 shows a horizontal cross-sectional view of the elevator.

The elevator may comprise a car 10, an elevator shaft 20, hoisting machinery 30, ropes 42, and a counterweight 41. A separate or an integrated car frame 11 may surround the car 10.

The hoisting machinery 30 may be positioned in the shaft 20. The hoisting machinery may comprise a drive 31, an electric motor 32, a traction sheave 33, and a machinery brake 34. The hoisting machinery 30 may move the car 10 in a first vertical direction Z upwards and downwards in the vertically extending elevator shaft 20. The machinery brake 34 may stop the rotation of the traction sheave 33 and thereby the movement of the elevator car 10.

The car frame 11 may be connected by the ropes 42 via the traction sheave 33 to the counterweight 41. The car frame 11 may further be supported with guiding means 27 at guide rails 25 extending in the vertical direction in the shaft 20. The guiding means 27 may comprise rolls rolling on the guide rails 25 or gliding shoes gliding on the guide rails 25 when the car 10 is moving upwards and downwards in the elevator shaft 20. The guide rails 25 may be attached with fastening brackets 26 to the side wall structures 21 in the elevator shaft 20. The guiding means 27 keep the car 10 in position in the horizontal plane when the car 10 moves upwards and downwards in the elevator shaft 20. The counterweight 41 may be supported in a corresponding way on guide rails that are attached to the wall structure 21 of the shaft 20.

The wall structure 21 of the shaft 20 may be formed of solid walls 21 or of open beam structure or of any combination of these. One or more of the walls may thus be solid and one or more of the walls may be formed of an open beam structure. The shaft 20 may comprise a front wall 21A, a back wall 21B and two opposite side walls 21C, 21D. There may be two guide rails 25 for the car 10. The two car guide rails 25 may be positioned on opposite side walls 21C, 21D. There may further be two guide rails 25 for the counterweight 41. The two counterweight guide rails 25 may be positioned on the back wall 21B.

The guide rails 25 may extend vertically along the height of the elevator shaft 20. The guide rails 25 may thus be formed of guide rail elements of a certain length e.g. 5 m. The guide rail elements 25 may be installed end-on-end one after the other. The guide rail elements 25 may be attached to each other with connection plates extending between the end portions of two consecutive guide rail elements 25. The connection plates may be attached to the consecutive guide rail elements 25. The ends of the guide rails 25 may comprise locking means for positioning the guide rails 25 correctly in relation to each other. The guide rails 25 may be attached to the walls 21 of the elevator shaft 20 with support means at support points along the height of the guide rails 25.

The car 10 may transport people and/or goods between the landings in the building.

FIG. 2 shows plumb lines PL1, PL2 in the shaft 20, which may be produced by plumbing of the shaft 20 at the beginning of the installation of the elevator. The plumb lines PL1, PL2 may be formed with traditional vires or with light sources e.g. lasers having the beams directed upwards along the plumb lines PL1, PL2. One plumb line and a gyroscope or two plumb lines are normally needed for a global measurement reference in the shaft 20.

FIG. 1 shows a first direction Z, which is a vertical direction in the elevator shaft 20. FIG. 2 shows a second direction X, which is the direction between the guide rails (DBG) and a third direction Y, which is the direction from the back wall to the front wall (BTF) in the shaft 20. The second direction X is perpendicular to the third direction Y. The second direction X and the third direction Y are perpendicular to the first direction Z.

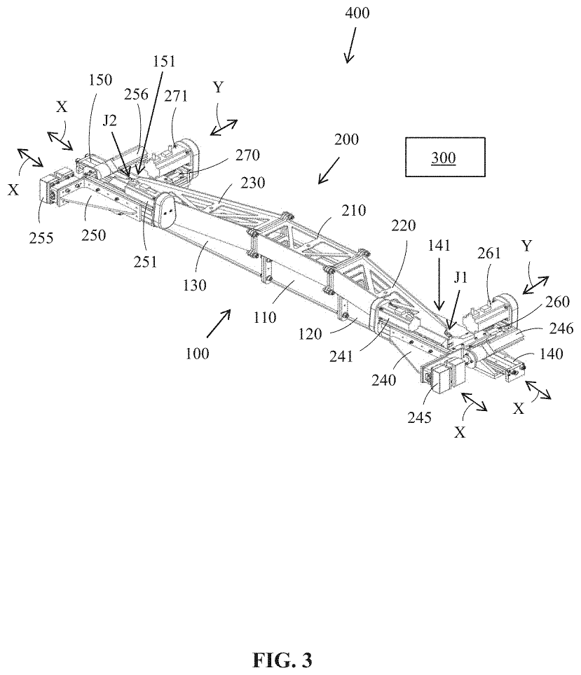

FIG. 3 shows an isometric view of an apparatus for aligning guide rails in an elevator.

The apparatus 400 for aligning guide rails 25 may comprise a positioning unit 100 and an alignment unit 200.

The positioning unit 100 may comprise a longitudinal support structure with a middle portion 110 and two opposite end portions 120, 130. The two opposite end portions 120, 130 may be mirror images of each other. There could be several middle portions 110 of different lengths in order to adjust the length of the positioning unit 100 to different elevator shafts 20. The positioning unit 100 may further comprise first attachment means 140, 150 at both ends of the positioning unit 100. The first attachment means 140, 150 may be movable in the second direction X i.e. the direction between the guide rails (DBG). The positioning unit 100 may extend across the elevator shaft 20 in the second direction X. The first attachment means 140, 150 may be used to lock the positioning unit 100 between the wall structures 21 and/or dividing beams and/or brackets 26 in the elevator shaft 20. An actuator 141, 151 (position shown only schematically in the figure) e.g. a linear motor in connection with each of the first attachment means 140, 150 may be used to move each of the first attachment means 140, 150 individually in the second direction X.

The alignment unit 200 may comprise a longitudinal support structure with a middle portion 210 and two opposite end portions 220, 230. The two opposite end portions 220, 230 may be mirror images of each other. There could be several middle portions 210 of different lengths in order to adjust the length of the alignment unit 200 to different elevator shafts 20. The alignment unit may further comprise second attachment means 240, 250 at both ends of the alignment unit 200. The second attachment means 240, 250 may be movable in the second direction X. An actuator 241, 251 e.g. a linear motor may be used to move each of the second attachment means 240, 250 individually in the second direction X. Each of the second attachment means 240, 250 may further comprise gripping means positioned at the end of the second attachment means 240, 250. The gripping means may be formed of jaws 245, 255. The jaws 245, 255 may be movable in the third direction Y perpendicular to the second direction X. The jaws 245, 255 may thus grip on the opposite side surfaces of the guide rails 25. An actuator 246, 256 e.g. a linear motor may be used to move each of the jaws 245, 255 individually in the third direction Y. The alignment unit 200 may be attached to the positioning unit 100 at each end of the positioning unit 100 with support parts 260, 270. The support parts 260, 270 may be movable in the third direction Y in relation to the positioning unit 100. The alignment unit 200 may be attached with articulated joints J1, J2 to the support parts 260, 270. An actuator 261, 271 e.g. a linear motor can be used to move each of the support parts 260, 270 individually in the third direction Y. The articulated joints J1, J2 make it possible to adjust the alignment unit 200 so that it is non-parallel to the positioning unit 100.

The two second attachment means 240, 250 may be moved with the actuators 241, 251 only in the second direction X. It would, however, be possible to add a further actuator to one of the second attachment means 240, 250 in order to be able to turn said second attachment means 240, 250 in the horizontal plane around an articulated joint. It seems that such a possibility is not needed, but such a possibility could be added to the apparatus 500 if needed.

The first attachment means 140, 150, the second attachment means 240, 250 may be moved individually with respective actuators 141, 151, 241, 251 in the second direction X. The gripping means 245, 255 may be moved individually with respective actuators 246, 256 in the third direction Y. The support parts 260, 270 may be moved individually with respective actuators 261, 271 in the third direction Y in relation to the positioning unit 100. The attachment of the alignment unit 200 via articulated joints J1, J2 to the positioning unit 100 makes it possible to adjust the alignment unit 200 so that it is non-parallel to the positioning unit 200.

The apparatus 400 may be operated by a mechanic through a control unit 300. The control unit 300 may be attached to the apparatus 400. Another possibility could be to use a separate control unit 300 positioned e.g. outside the shaft 20. The separate control unit 300 may be connected via a cable or via a wireless connection to the apparatus 400. The control unit 300 may be used to control all the actuators used in the apparatus 400 i.e. the actuators 141, 142 moving the first attachment means 140, 150, the actuators 241, 242 moving the second attachment means 240, 250, the actuators 246, 256 moving the gripping means 245, 255 and the actuators 261, 271 moving the support parts 260, 270.

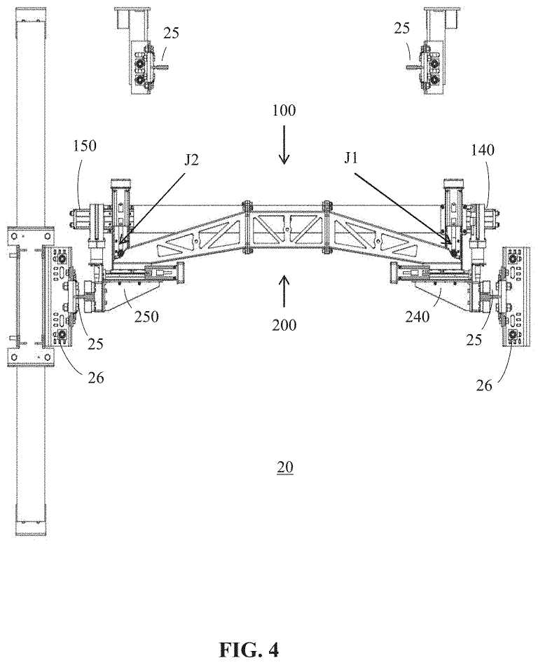

FIG. 4 shows a first phase of the operation of the apparatus of FIG. 3. The figure shows the brackets 26 on both sides of the shaft 20. The guide rails 25 are attached to the brackets 26 and the brackets 26 are attached to the wall structures in the shaft 20. The apparatus 400 may be supported on an installation platform and a mechanic may travel on the installation platform. The mechanic may operate the apparatus 400 through the control unit 300. The alignment unit 200 may be attached via the jaws 245, 255 at the ends of the second attachment means 240, 250 to the two opposite guide rails 25. The second attachment means 240, 250 may be movable in the second direction X and the jaws 245, 255 may be movable in the third direction Y so that they can grip on the opposite vertical side surfaces of the guide rails 25. The bracket 26 bolts may then be opened at both sides of the shaft 20 so that the guide rails 25 may be moved. The guide rails 25 on opposite sides of the shaft 20 may then be adjusted relative to each other with the alignment unit 200. The frame of alignment unit 200 is stiff so that the two opposite guide rails 25 will be positioned with the apexes facing towards each other when the gripping means 245, 255 grips the guide rails 25. There is thus no twist between the opposite guide rails 25 after this. The distance between the two opposite guide rails 25 in the direction (DBG) is also adjusted with the alignment unit 200. The position of each of the second attachment means 240, 250 in the second direction X determines said distance.

There may be a plump line formed in the vicinity of each guide rail 25 (shown in FIG. 2). There may further be a contact-free measurement system measuring the distance i.e. in the DBG and the BFT direction from the guide rail 25 to the plumb line PL1, PL2 that is in the vicinity of said guide rail 25. The system may further calculate the difference to a predetermined target value. Based on the differences of each guide rail 25 from the target value, the needed control values (DBG, BTF and twist) are calculated. The control values are then transformed into incremental steps, which are fed as control signals to the control units of the linear motors in the apparatus 400. The DBG can also be measured based on the motor torque, which indicates when the second attachment means 240, 250 have reached their end position and are positioned against the guide rails 25. The position of the linear motors can then be read from the display of the control unit 300. The apparatus 400 can thus calculate the DBG based on the distance of the guide rails 25 to the plumb lines and based on the position of each of the second attachment means 240, 250 in the second direction X.

EP 2 872 432 B1 discloses a contact-free measuring system that may be used for measuring the distance in the DGB and the BFT direction from the guide rail 25 to the plumb line PL1, PL2 that is in the vicinity of said guide rail 25. The measuring system may comprise at least one sensor arrangement mounted on a carrier to travel vertically along the guide rail. The sensor arrangement comprises a frame, at least one guide shoe connected to the frame for sliding and/or rolling along a guide surface of the guide rail, a bias means for placing and biasing the frame against the guide surface, and at least one sensor means for sensing the position of the plumb line PL1, PL2 with respect to the frame.

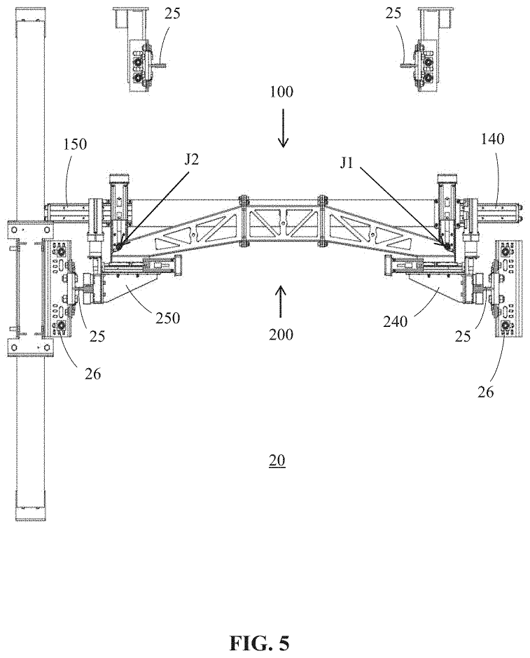

FIG. 5 shows a second phase of the operation of the apparatus of FIG. 3. The positioning unit 100 is locked to the wall structure 21 or other support structures in the elevator shaft 20 with the attachment means 260, 270. The alignment unit 200 is in a floating mode in relation to the positioning unit 100 when the positioning unit 100 is locked to the wall structure 21 of the elevator shaft 20. The guide rails 25 can now be adjusted with the alignment unit 200 and the positioning unit 100 in relation to the shaft 20. The bracket 26 bolts are then tightened. The apparatus 400 can now be transported to the next bracket 26 location where the first phase and the second phase of the operation of the apparatus may be repeated.

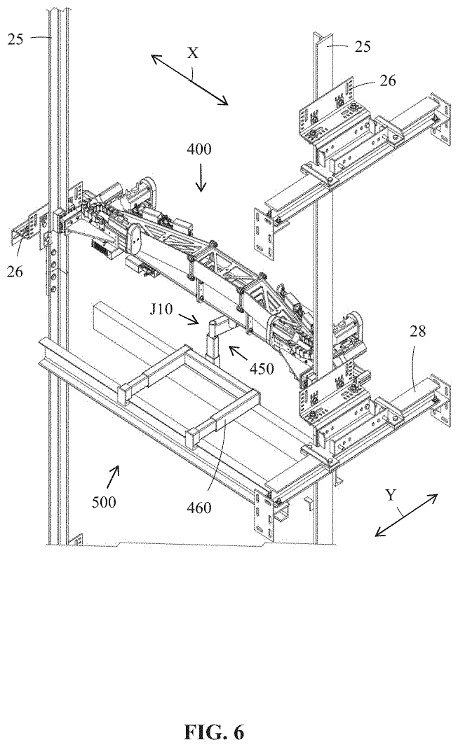

FIG. 6 shows an axonometric view of an elevator shaft with the alignment apparatus and an installation platform.

The figure shows car guide rails 25, an installation platform 500 and the apparatus 400 for aligning the guide rails 25. The apparatus 400 for aligning the guide rails 25 may be attached with a support arm 450 to a support frame 460 and the support frame 460 may be attached to the installation platform 500. The installation platform 500 may be movable upwards and downwards along the car guide rails 25 in the shaft 20. The apparatus 400 for aligning the guide rails 25 is in this embodiment movable in the second direction X and in the third direction Y in relation to the installation platform 500. This can be achieved with one or several joints J10 in the support arm 450. The support frame 460 can also be arranged to be movable in the second direction X and in the third direction Y. The position of the support arm 450 in relation to the installation platform 500 must be measured in order to determine the position of the alignment apparatus 400 in relation to the installation platform 500. The guide rails 25 to the left in the figure may be attached with brackets 26 to a wall structure of the shaft 20. The guide rails 25 to the right may be attached with brackets 26 to a divider beam 28 running across the shaft 20.

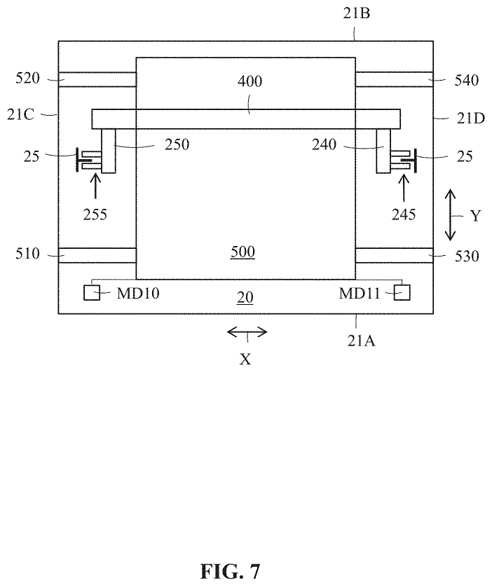

FIG. 7 shows a horizontal cross section of the elevator shaft provided with an installation platform.

The figure shows an installation platform 500, the apparatus 400 for aligning guide rails and two measuring devices MD10, MD11 supported on the installation platform 500. The installation platform 500 may comprise support arms 510, 520, 530, 540 arranged on opposite sides of the installation platform 500 and being movable in the second direction X for supporting the installation platform 500 on the opposite side walls 21C, 21D of the shaft 20. The gripping means 245, 255 of the second attachment means 240, 250 may grip the opposite guide surfaces of the car guide rails 25. The car guide rails 25 may thus be aligned with the apparatus 400 for alignment of guide rails as described earlier in this application. The installation platform 500 may be locked in place with the support arms 510, 520, 530, 540.

The position of the installation platform 500 in relation to the shaft 20 may be determined with the measuring devices MD10, MD11 based on the plumb lines PL1, PL2 once the installation platform 500 is locked in the shaft 20. The measuring devices MD10, MD11 may be based on sensor measuring without contact the position of the plumb lines PL1, PL2 being formed of wires. Another possibility is to use light sources e.g. lasers on the bottom of the elevator shaft producing upwards directed light beams that can be measured with the measuring devices MD10, MD11 on the installation platform 500. The measuring devices MD10, MD11 could be light sensitive sensors or digital imaging devices measuring the hit points of the light beams produced by the light sources. The light source could be a robotic total station, whereby the measuring devices MD10, MD11 would be reflectors reflecting the light beams back to the robotic total station. The robotic total station would then measure the position of the measuring devices MD10, MD11.

The alignment apparatus 400 may be attached stationary to the installation platform 500, whereby the position of the apparatus 400 can be determined indirectly based on the position of the installation platform 500. The position of the guide rails 25 may be determined indirectly based on the position of the apparatus 400. The alignment apparatus 400 can on the other hand be attached movable to the installation platform 500, whereby sensors can be arranged on the installation platform 500 in order to measure the position of the alignment apparatus 400 on the installation platform 500.

The form of the guide rails 25 is naturally not limited to the T form disclosed in the figures. The guide rails 25 can be of any form, but the gripping means etc. must naturally be adapted to the form of the guide rails 25.

The support brackets 26 used to attach the guide rails 25 to the wall structures of the shaft 20 can be of any construction.

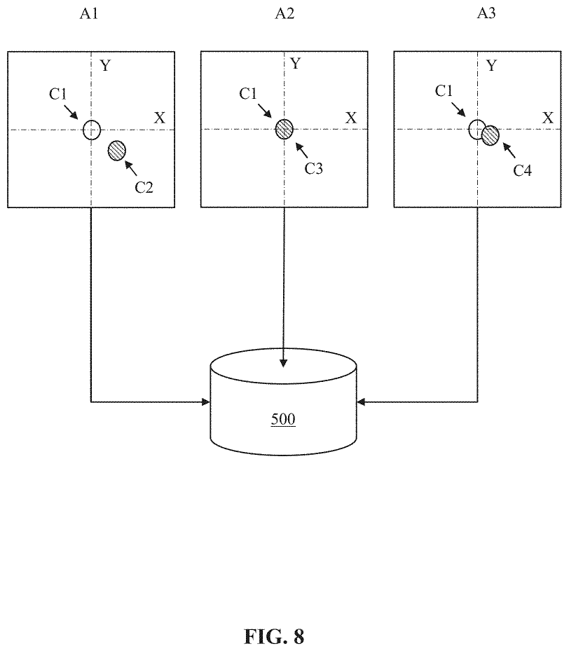

FIG. 8 shows the principle of collecting measured position data of a guide rail.

The horizontal axis X denotes the direction between the guide rails (DBG) and the vertical axis Y denotes the back to front (BTF) direction in the figures. The position data may be categorized by at least one of the parameters in a first group of parameters or any combination of the parameters in the first group of parameters comprising: the type of the guide rail, the type of the fastening brackets, the number of the fastening bracket, the type of fastening clips, the bracket distance, and optionally the type of divider beam if the guide rail is attached via divider beams to the wall structures of the elevator shaft. One or several of these parameters may have an influence on the spring back of the guide rail.

FIG. 8A1 shows the position of the guide rail after the bolts of the fastening bracket of the guide rail have been opened. Point C1 indicates the correct position of the guide rail in the X direction and in the Y direction. Point C2 indicates the position of the guide rail after the fastening bolts of the fastening bracket have been opened. There is typically no tension in the rail in this position.

FIG. 8A2 shows the position of the guide rail after the adjustment of the guide rail. Point C1 indicates the correct position of the guide rail in the X direction and in the Y direction. Point C3 indicates the position of the guide rail after the guide rail has been adjusted into the correct positions. The point C1 and the point C3 are concentric in this situation. A force with a direction is created into the guide rail when the guide rail is moved into the correct position.

FIG. 8A3 shows the position of the guide rail after the bolts in the fastening bracket have been tightened and the guide rail has been released. Point C1 indicates the correct position of the guide rail in the X direction and in the Y direction. Point C4 indicates the position of the guide rail after the guide rail has been released and the spring back of the guide rail has occurred. The point C4 deviates thus from the correct position C1 due to the spring back of the guide rail. The spring back length and direction of the guide rail is thus present in this point C4.

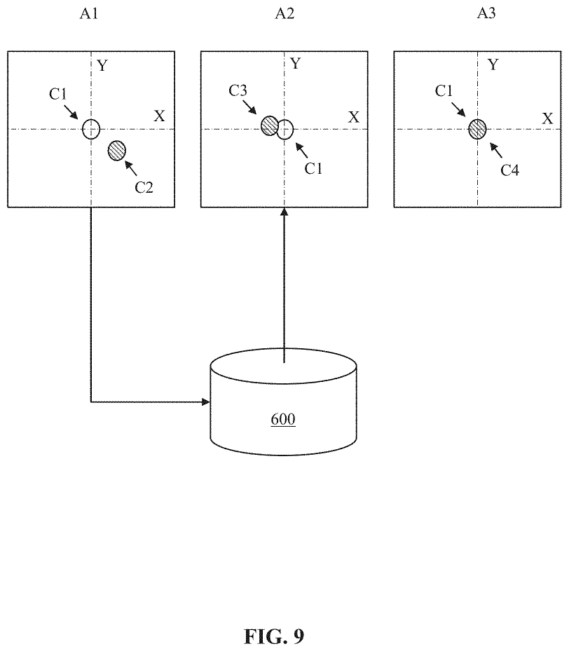

FIG. 9 shows the principle of using measured position data in the alignment of a guide rail.

The horizontal axis X denotes the direction between the guide rails (DBG) and the vertical axis Y denotes the back to front (BTF) direction in the figures. The measured position data may be categorized by at least one of the parameters in a first group of parameters or any combination of the parameters in the first group of parameters comprising: the type of the guide rail, the type of the fastening bracket, the number of the fastening bracket, the type of fastening clips, the bracket distance, and optionally the type of the divider beam if the guide rail is attached via divider beams to the wall structures in the shaft. One or several of these parameters may have an influence on the spring back of the guide rail.

FIG. 9A1 shows the position of the guide rail after the bolts of the fastening bracket of the guide rail have been opened. Point C1 indicates the desired position of the guide rail in the X direction and in the Y direction. Point C2 indicates the initial position of the guide rail after the bolts of the fastening bracket have been opened. This positions data C1, C2 of the guide rail may be stored in a mathematical model 600.

FIG. 9A2 shows the position of the guide rail after the adjustment of the guide rail. Point C1 indicates the desired position of the guide rail in the X direction and in the Y direction. Point C3 indicates the predicted position of the guide rail which is calculated by the mathematical model 600. The point C3 is not concentric with the point C1. This deviation of point C3 from point C1 takes into consideration the spring back of the guide rail. An estimate of the spring back of the guide rail has been calculated with the mathematical model and this estimated spring back is taken into consideration when the mathematical model determines the predicted position C3.

FIG. 9A3 shows the position of the guide rail after the bolts in the fastening bracket have been tightened and the guide rail has been released. Point C1 indicates the correct position of the guide rail in the X direction and in the Y direction. Point C4 indicates the final position of the guide rail after the guide rail has been released and the spring back of the guide rail has occurred. The point C4 is now concentric with the desired position C1. The mathematical model has predicted the spring back of the guide rail correctly which means that the guide rail is now after the spring back has occurred in the desired position. There is thus no need for any trial and error corrections of the position of the guide rail.

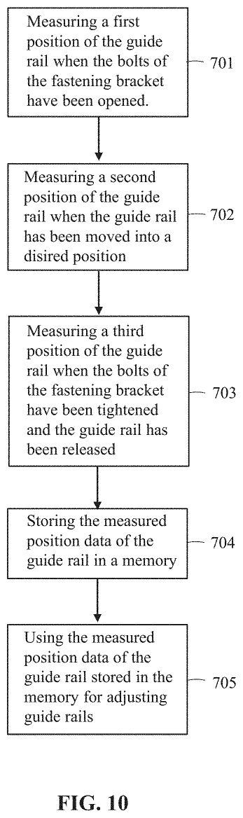

FIG. 10 shows a flow diagram for aligning guide rails of an elevator.

Step 701 comprises measuring a first position of the guide rail when the bolts of the fastening bracket have been opened.

Step 702 comprises measuring a second position of the guide rail when the guide rail has been moved into a desired position.

Step 703 comprises measuring a third position of the guide rail when the bolts of the fastening bracket have been tightened and the guide rail has been released. The difference in the second position and the third position representing a spring back of the guide rail.

Step 704 comprises storing the measured position data of the guide rail in a memory.

Step 705 comprises using the measured position data of the guide rail stored in the memory for adjusting guide rails.

The alignment of the guide rails in a shaft may simply be done based on guide rail position data collected from earlier alignments made in the same shaft.

The alignment of the guide rails in a shaft may on the other hand be done based on guide rail position data collected from earlier alignment processes in many different shafts. Guide rail position data may be collected ongoing from all alignment processes that are done.

Machine learning may also be applied to the mathematical model to improve the mathematical model. The predicted position of the guide rail produced by the mathematical model might not be quite correct in all instances. There might thus be a need to tune the mathematical model. This may be done by applying machine learning to the mathematical model. Error data in the predicted position may be measured during the installation and supplied to the mathematical model to tune the mathematical model.

The measured position data may be fitted into a mathematical model. Any mathematical model suitable for solving multivariable optimization problems may be used in the invention. A simple linear algorithm could e.g. be used if we have all meaningful variables stored and the spring back is not completely stochastic. Regression analysis could naturally also be used to fit a mathematical model on the measured position data.

The use of the invention is naturally not limited to the type of elevator disclosed in the figures, but the invention can be used in any type of elevator e.g. also in elevators lacking a machine room and/or a counterweight.

It will be obvious to a person skilled in the art that, as the technology advances, the inventive concept can be implemented in various ways. The invention and its embodiments are not limited to the examples described above but may vary within the scope of the claims.

1. A method for aligning guide rails of an elevator, the method comprising
measuring a first position of the guide rail at a fastening bracket of the guide rail when the bolts of the fastening bracket have been opened,
measuring a second position of the guide rail at the fastening bracket when the guide rail has been moved into a desired position,
measuring a third position of the guide rail at the fastening bracket when the bolts of the fastening bracket have been tightened and the guide rail has been released, the difference in the second position and the third position representing a spring back of the guide rail,
storing the measured position data of the guide rail in a memory,
using the measured position data of the guide rail stored in the memory for adjusting guide rails.

2. The method as claimed in claim 1, further comprising
categorizing the measured position data of the guide rails by at least one of the parameters in a first group of parameters or any combination of the parameters in the first group of parameters comprising: the type of the guide rail, the type of the fastening bracket, the number of the fastening bracket, the type of fastening clips, the bracket distance, and optionally the type of the divider beam if the guide rail is attached via divider beams to the wall structures of the elevator shaft.

3. The method as claimed in claim 2, further comprising
selecting the nearest match of the fastening bracket to be adjusted from the position data stored in the memory and adjusting the position of the guide rail based on position data of said nearest match.

4. The method as claimed in claim 1, further comprising
fitting the measured position data into a mathematical model.

5. The method as claimed in claim 4, further comprising
using an output of the mathematical model to determine the adjustment of the position of the guide rail at a fastening bracket.

6. The method as claimed in claim 5, further comprising
using regression analysis when fitting the mathematical model to the measurement data.

7. The method as claimed in claim 5, further comprising
using a regression model as the mathematical model.

8. The method as claimed in claim 6, further comprising
using the mathematical model as a machine learning algorithm.

9. The method as claimed in claim 4, further comprising
using guide rail position data measured from several different shafts to train the mathematical model.

10. The method as claimed in claim 1, further comprising
using an alignment apparatus for aligning the guide rails, the alignment apparatus comprising
a positioning unit extending horizontally across the elevator shaft in a second direction and comprising first attachment means movable in the second direction at each end of the positioning unit for supporting the positioning unit on the opposite wall structures or other support structures in the elevator shaft,
an alignment unit extending across the elevator shaft in the second direction and being supported with support parts on each end portion of the positioning unit so that each end portion of the alignment unit is individually movable in relation to the positioning unit in a third direction perpendicular to the second direction, and comprising second attachment means movable in the second direction at each end of the alignment unit for supporting the alignment unit on opposite guide rails in the shaft, said second attachment means comprising gripping means for gripping on the guide rail, whereby
opposite guide rails can be adjusted in relation to each other and in relation to the elevator shaft with the alignment apparatus.

11. The method as claimed in claim 10, further comprising
controlling the alignment apparatus via a controller.

12. The method as claimed in claim 10, further comprising using a contact-free measuring system for measuring the distance from the guide rail to a plumb line arranged in the vicinity of the guide rail.

13. A computer program product comprising program instructions, which, when run on a computer, causes the computer to perform a method as claimed in claim 1.
